(19) United States
(12) Patent Application Publication
(10) Pub. No.: US 2015/0307686 A1
(43) Pub. Date: Oct. 29, 2015

(54) PLA POLYMER COMPOSITION

(71) Applicant: Arkema France, Colombes (FR)

(72) Inventors: Sébastien QUINEBECHE, Bernay (FR); Jean-Jacques FLAT, Goupillieres (FR)

(73) Assignee: Arkema France, Colombes (FR)

(21) Appl. No.: 14/420,524

(22) PCT Filed: Jul. 11, 2013
(86) PCT No.: PCT/FR2013/051666

§ 371 Date: May 15, 2015

(30) Foreign Application Priority Data
Aug. 9, 2012 (FR) 1257724

(51) Int. Cl. C08K 5/00; B32B 27/36; B32B 27/08; C08G 63/91; C08K 3/00

(52) U.S. Cl. CPC C08K 5/0008; C08G 63/912; C08K 3/0008; B32B 27/08; B32B 27/36; B32B 2250/03; B32B 2307/7163; B32B 2439/00; B32B 2307/7265; B32B 2307/7242

(57) ABSTRACT

The present invention relates to a polymer composition, said polymer having a main chain consisting of a polylactic acid, the main chain including a plurality of unsaturated acid anhydride grafts, characterized in that said main chain also includes activating comonomer grafts. The invention also relates to a manufacturing method and to a use linked to said polymer composition.

### FIELD OF THE INVENTION

The invention relates to a polymer composition based on polylactic acid, more precisely polylactic acid having specific cografting intended to impart particularly advantageous use properties thereto without degrading the physical properties thereof. The invention also relates to a binder comprising said composition, able to be used in coextrusion, having good adhesion properties and able to be used in multilayer structures.

The market for “eco polymers” (based on renewable and/or biodegradable polymers) is experiencing great expansion, especially in food packaging. This blossoming is due to the need to find an alternative to fossil materials and to reduce pollution. The potential of biorenewable and/or biodegradable polymers is clear to see and one of the most commonly used of these polymers consists of polylactic acid polymer compositions.

Hereinafter, the term “polymer composition” is understood to mean compositions formed of polymers, copolymers, terpolymers and so on.

These polymers have a limited impact on the environment when compared to polymers derived from non-biodegradable fossil resources. Biorenewable polymers enable the consumption of fossil materials to be limited and enable resources derived from plant cultivation to be used. Biodegradable polymers, for their part, are transformed quickly into products which can be absorbed in whole or in part by plants present in the environment.

However, as such these eco polymers cannot generally fulfill all the specifications required in industry, in particular in packaging or more generally when the polymers must have outstanding use properties.

Indeed, in this sector, the structures used must in particular have good mechanical and chemical properties, water and gas barrier properties and/or sufficient weldability.

### PRIOR ART

To achieve the level of required properties (mechanical properties, chemical properties, etc.), it has therefore been proposed to combine these eco polymers in multilayer structures. Since these materials are generally incompatible, this type of combination cannot be achieved without the use of binders. The use in binders of polymers modified by grafting with functional molecules is known to those skilled in the art

Polymer compositions based on polylactic acid are described, for example, in the paper “Maleation of Polylactide (PLA) by Reactive Extrusion” published in 1998 by D. Carlson, L. Nie, R. Narayan and P. Dubois (notably “Journal of Applied Polymer Science”, Vol. 72, 477-485 (1999)).

Thus, it has already been proposed, in particular in the abovementioned paper, to graft, by the radical route in the molten state, functional groups consisting of maleic anhydride so as to provide PLA with a reactive unit.

Nevertheless, the addition of maleic anhydride grafts to PLA by the radical route has a large number of drawbacks.

First of all, the addition of maleic anhydride grafts leads to a very significant increase in the MFI (Melt Flow Index) of PLA, such that this composition becomes extremely fluid. Now, for some applications such as packagings with multilayer structures, which necessitate the extrusion of a film, the MFI of the polymer composition should ideally be between 1 and 6 g/10 minutes (gram per ten minutes) at 190° C. under 2.16 kilograms.

Moreover, the addition of maleic anhydride grafts to PLA by the radical route gives PLA a very vibrant orangey color, which is incompatible with its use in many areas of plastics, even more so when complete transparency, i.e. with no or minimal coloring of the transparent film, is being sought. Therefore, it is desired that the composition have a value of less than 65, preferably of less than 35, more preferably of less than 20, in the yellowness index test (ASTM E313-96).

Finally, the addition of maleic anhydride grafts to PLA degrades the thermal stability thereof in the molten state.

It should be noted that PLA-based polymers have a specific chemical structure which sets them apart in the large family of eco polymers notably comprising polyhydroxyalkanoate or PHA homo- or copolymers, poly(alkylene succinates) or PASs, poly(butylene succinate adipate) or PBSA, poly(butylene adipate terephthalate) or PBAT, poly(caprolactone) or PCL, poly(trimethylene terephthalate) or PTT, thermoplastic starch or TPS, polyethylene succinate or PES, polybutylene succinate or PBS, poly(hydroxybutyrates) or PHBs, hydroxybutyrate-valerate copolymers or PHBVs, such as poly(3-hydroxybutyrate)-poly(3-hydroxyvalerate), copolymers of hydroxybutyrate-hexanoate or PHBHx and hydroxybutyrate-octanoate copolymers or PHBOs.

In this connection, the document JP 3134011 is known which discloses an example of a composition comprising polycaprolactone (PCL), more precisely caprolactone-styrene-maleic anhydride copolymers, which is excluded from the PLA family. Moreover, to obtain these compositions, this document provides for the use of a solvent at around 70° C. for close to ten hours, whereas the method of manufacture of the present invention is fundamentally different. Finally, this document does not aim to solve the specific technical problems raised here and solved by virtue of the present invention.

Thus, the PLA-based polymer compositions comprising maleic anhydride grafts are thermoplastic materials of great interest particularly in respect of their functionality but, until now, the prior art has not included such compositions able to remedy the drawbacks enumerated hereinabove.

### BRIEF DESCRIPTION OF THE INVENTION

Surprisingly, after many tests, the applicant has discovered that the three main drawbacks mentioned above relating to PLA polymer compositions comprising maleic anhydride grafts are very significantly reduced or even obviated by virtue of the addition of grafts of a very specific type.

Thus, the present invention relates to a polymer composition, said polymer having a main chain consisting of a polylactic acid, the main chain comprising a plurality of unsaturated acid anhydride grafts, characterized in that said main chain also comprises activating comonomer grafts.

The invention notably has the following advantages:
a rheology which satisfies the industrial transformation requirements,
a transparency which is more conventional and acceptable for the various applications of the product; i.e. not having any coloring or having a very slight coloring,
an improved thermal stability in the molten state.

Other features and advantages of the present invention are presented hereinafter:
advantageously, the unsaturated acid anhydride grafts preferably consist of maleic anhydride;
advantageously, the activating comonomer grafts consist of styrene monomers;
preferably, the styrene monomers consist of styrene;
according to a particular feature of the invention, the amount of activating comonomers in the composition is between 0.011 and 2.1% by weight, such that in the composition said activating comonomers represent between 0.01 and 2 molar equivalents of the unsaturated acid anhydride;
preferably, the amount of activating comonomers in the composition is between 1.2 and 1.9% by weight, such that in the composition the activating comonomers represent between 1.1 and 1.8 molar equivalents of the unsaturated acid anhydride;
according to one possibility afforded by the invention, the composition may also comprise additives present at between 10 and 50 000 ppm and the additives comprise antioxidants, UV protection agents, processing aids, such as fatty amides, stearic acid and salts thereof, fluoropolymers, antifogging agents, antiblocking agents, such as silica or talc, antistatic agents, nucleating agents and colorants;
according to a particular feature of the invention, the polymer also comprises at least one secondary chain consisting of a polylactic acid.

Thus, it is conventional for the end polymer to have a main chain, to which one or more polylactic acid chains affix themselves during the method of requirements preparation/requirements; these polylactic acid chains may optionally comprise the same grafts as the main chain, namely unsaturated acid anhydride grafts and activating comonomer grafts. It should be noted that, during the preparation of the polymer according to the invention, chain cleavages may occur at the same time as branching events (which give rise to this secondary chain), with these two concomitant events (cleavages and branching) giving rise to a final rheology as presented hereinafter in the tests undertaken;
thus, preferably, the secondary chain comprises at least one unsaturated acid anhydride graft, preferably maleic anhydride, and/or at least one activating comonomer graft, preferably styrene monomers and more preferably styrene.

The invention also relates to a method of manufacture of the polymer composition as claimed in any one of the preceding claims, characterized in that it comprises a step of extrusion, via an extruder, of the polylactic acid (PLA) polymer, in the presence of radical generators, unsaturated acid anhydride, preferably maleic anhydride, and activating monomers, preferably styrene monomers and more preferably styrene; the temperature during this extrusion step being chosen so that the polylactic acid polymer is present in the molten state and that the radical generator entirely decomposes during said step.

According to a particular aspect of the invention, the polylactic acid (PLA) polymer, the radical generator, the unsaturated acid anhydride and the activating monomers are introduced into the extruder at the same time, either with all or some of these elements having been mixed beforehand to form a uniform mixture or with all or some of these elements being introduced simultaneously into the extruder.

Advantageously, the method of manufacture according to the invention comprises a final step of venting.

Finally, the present invention also relates to a multilayer structure, such as a film or a sheet, comprising at least three adjacent polymer layers, namely a central binder-forming layer having the primary role of ensuring bonding between the two peripheral layers, characterized in that the central layer comprises the composition as described hereinabove.

In the conventional case of a multilayer structure comprising five adjacent superimposed layers, the structure will comprise two binder-forming layers situated at level 2 and level 4 so as to bond the two peripheral layers (layers 1 and 5) to the central layer (layer 3).

It will be noted moreover that the binder-forming layer comprising the composition according to the invention may include other components intended to impart other mechanical/physical/chemical properties to said layer.

The two adjacent layers are arranged in combination with the layer comprising the composition according to the invention which is described hereinabove, according to techniques well known to those skilled in the art, notably by coextrusion.

By way of non limiting example of layers which may constitute one or the other (or both) of these two adjacent layers, mention will be made of the layer or coating compositions disclosed in the following documents: EP 1 136 536, EP 802 207, WO 97/27259, EP 1 022 310, EP 742 236, EP 1 400 566, FR 2 850 975, WO 01/34389, EP 2 029 672, EP 629 678, EP 1 375 594, FR 2 915 203 and FR 2 916 203.

### DETAILED DESCRIPTION OF THE INVENTION

The term “polylactide polymers” is understood to mean, for example, polymers or copolymers of lactic acid (PLA) or else polymers or copolymers of glycolic acid (PGA).

In the context of the present invention, the PLA polymer is cografted by unsaturated acid anhydride and at least one activating comonomer.

It will be noted that the degree of grafting, as shown in the examples, has a considerable influence on the properties of the polymer composition. The amount of monomer grafted may for example be readily determined by those skilled in the art by virtue of the technique of infrared spectroscopy or acid-base titration followed by potentiometry, for the unsaturated acid anhydrides, and by virtue of the technique of infrared spectroscopy or NMR (Nuclear Magnetic Resonance) spectroscopy, for the activating comonomers.

Activating comonomers is understood to mean any monomer with an unsaturation and characterized by a parameter “e” which is lower than the value of the parameter “e” for maleic anhydride, in this instance 2.25.

The parameters “e” and “Q” (this parameter “Q” is given here purely by way of indication, in view of the fact that it is often presented in conjunction with the parameter e) are known to those skilled in the art as being the two parameters of the Alfrey-Price scheme. For more details, reference will advantageously be made to the following publication: T. Alfrey Jr. and C. C. Price, J. Polym. Sci., 2, 101 (1947).

Indeed, in conventional radical copolymerization, the polar effects of the growing radical chain with respect to the approaching monomer are explained by the Alfrey-Price scheme and its two parameters, “Q” and “e”.

It is well known that the propensity for copolymerization between the two comonomers tends to increase as the difference between the values “e” for the two comonomers increases.

By way of example of these activating comonomers, without this list being exhaustive in nature, the styrene monomers are understood. In the present description, styrene monomer should be understood as meaning any monomer or combination of monomers having the chemical structure of styrene. As examples of styrene monomers, the following may be mentioned: styrene, α-methylstyrene, ortho-methylstyrene, meta-methylstyrene, para-methylstyrene, ethylstyrene, isopropenyltoluene, vinylnaphthalene, isopropenylnaphthalene, vinylbiphenyl, dimethylstyrene, tert-butylstyrene, hydroxystyrene, alkoxystyrenes, acetoxystyrenes, bromostyrene, chlorostyrene, vinylbenzoic acid, cinnamic acid or else alkyl cinnamates.

Activating comonomers is also understood to mean 1,1-diphenylethylene, stilbene, phenylacetylene, vinylpyridine, 2-isopropenylnaphthalene, butadiene, isoprene, dimethylbutadiene, cyclopentene, alkyl vinyl ethers, alkyl vinyl sulfides, phenyl vinyl ethers, alkylphenyl vinyl ethers, vinyl acetate, methyl methacrylate, naphthyl methacrylate, furan, indole, vinylindole, N-vinylpyrrolidone, N-vinylcarbazole and vinyl chloride.

The styrene monomers represent the preferred activating comonomers and even more preferably is styrene.

With regard to the grafting monomer, it may be chosen, relative to the unsaturated acid anhydride grafts, from unsaturated carboxylic acids or functional derivatives thereof.

Examples of unsaturated carboxylic acids are those having from 2 to 20 carbon atoms, such as acrylic, methacrylic, maleic, fumaric and itaconic acids.

The functional derivatives of these unsaturated carboxylic acids comprise the anhydrides, the ester, amide and imide derivatives and the metal salts (such as the alkali metal salts) of these unsaturated carboxylic acids.

Particularly preferred grafting monomers are unsaturated dicarboxylic acids having from 4 to 10 carbon atoms and the functional derivatives thereof, particularly the anhydrides thereof.

These grafting monomers comprise, for example, maleic, fumaric, itaconic, citraconic, allylsuccinic cyclohex-4-ene-1,2-dicarboxylic, 4-methylcyclohex-4-ene-1,2-dicarboxylic, bicyclo[2.2.1]hept-5-ene-2,3-dicarboxylic and x-methylbicyclo[2.2.1]hept-5-ene-2,3-dicarboxylic acids and the functional derivatives thereof, and maleic, itaconic, citraconic, allylsuccinic, cyclohex-4-ene-1,2-dicarboxylic, 4-methylcyclohex-4-ene-1,2-dicarboxylic, bicyclo[2.2.1]hept-5-ene-2,3-dicarboxylic and x-methylbicyclo[2.2.1]hept-5-ene-2,2-dicarboxylic anhydrides.

Maleic anhydride (abbreviated to MAH) is preferred.

Other components known in the art may also be added to the grafted polymers of this invention in order to enhance the properties of the final material. Among these components, mention may be made of the additives customarily used during the processing of polymers, for example at contents of between 10 ppm and 50 000 ppm, such as antioxidants, UV protection agents, processing aids, such as fatty amides, stearic acid and salts thereof, fluoropolymers which are known as agents for preventing extrusion defects, antifogging agents and antiblocking agents, such as silica or talc. Other types of additives may also be incorporated in order to provide specific desired properties. Mention will be made, for example, of antistatic agents, nucleating agents and colorants.

### Preparation of the Composition According to the Invention

To obtain the composition based on PLA grafted by maleic anhydride, various known methods (reactive extrusion method, method in solution, method by irradiation or method in the solid state) may be used to graft a functional monomer such as maleic anhydride onto the PLA polymer. By way of example, grafting of maleic anhydride onto the PLA polymer may be carried out in the molten state in an extruder, in the presence of a radical generator. Suitable radical generators which may be used comprise t-butyl hydroperoxide, cumene hydroperoxide, diisopropylbenzene hydroperoxide, di-t-butyl peroxide, di-t-amyl peroxide, t-butyl cumyl peroxide, dicumyl peroxide, 1,3-bis(t-butylperoxyisopropyl)benzene, 2,5-dimethyl-2,5-di(t-butylperoxy)hexane, t-butyl peroxybenzoate, t-butyl peroxy-2-ethylhexanoate, OO-butyl O-(2-ethylhexyl) monoperoxycarbonate, OO-t-amyl O-(2-ethylhexyl) monoperoxycarbonate, acetyl peroxide, dibenzoyl peroxide, isobutyryl peroxide, bis-3,5,5-trimethylhexanoyl peroxide and methyl ethyl ketone peroxide.

The method of manufacture of the composition according to the invention is concerned more particularly with the cografting of a styrene monomer and maleic anhydride onto the PLA. The method of manufacture consists in extruding PLA polymer in a corotating twin-screw extruder in the presence of a radical generator, maleic anhydride and a styrene monomer. The temperature is chosen such that the reaction takes place in the molten state of the polymer and that the radical generator entirely decomposes in the time allocated to the extrusion. It is to be noted that venting is carried out at the end of the extruder in order to remove the radical generator decomposition products and the unreacted monomers from the PLA polymer.

### Exemplary Embodiment of the Composition According to the Invention

The compositions based on PLA grafted by maleic anhydride and styrene monomer were prepared in a Haake PTW 16/25 corotating twin-screw extruder. The PLA used is Ingeo® 2003D from NatureWorks, the styrene monomer used is the styrene supplied by Aldrich®, the maleic anhydride is CristalMan® and the radical generator is Luperox® 101 supplied by Arkema. A weight metering device was used to supply the extruder. In order to ensure a compositionally homogenous supply, the various constituents of the formulation were mixed in the bag before filling the metering device. For this purpose, the PLA was used in powder form, and the liquid constituents (styrene and Luperox® 101) were impregnated onto PLA powder. The extrusion conditions were: flow rate=1 kg/h, temperature=180° C. and screw speed=100 rpm. The extruder is equipped with a venting well enabling the devolatilization of residuals at the end of the extruder with the aid of a rotary vane pump (P=−0.95 bar in the venting well). The PLA polymer grafted by maleic anhydride and styrene leaving the extruder is cooled on contact with air on a conveyor belt and then pelletized using a pelletizer. The amount of maleic anhydride introduced is 1% by mass relative to the total mass of the various constituents. The amount of Luperox® 101 introduced is 0.4% by mass. The amount of styrene introduced is between 0 and 1.8% by mass such that the amount of styrene introduced represents between 0 and 1.7 molar equivalents of the maleic anhydride introduced.

### Tests Performed on the Compositions

The compositions tested are as follows:
composition No. 1: composition based on PLA grafted by maleic anhydride (without styrene monomers)
composition No. 2: composition based on PLA cografted by maleic anhydride and 0.5 equivalent of styrene monomers
composition No. 3: composition based on PLA cografted by maleic anhydride and 1 equivalent of styrene monomer
composition No. 4: composition based on PLA cografted by maleic anhydride and 1.2 equivalents of styrene monomer
composition No. 5: composition based on PLA cografted by maleic anhydride and 1.5 equivalents of styrene monomers
composition No. 6: composition based on PLA cografted by maleic anhydride and 1.7 equivalents of styrene monomers
PLA 2003D composition: composition formed of polylactic acid Ingeo® 2003D from NatureWorks (with neither maleic anhydride graft nor styrene graft)

The term “cografted by maleic anhydride and X equivalent(s) of styrene monomers” is understood to mean that, in the PLA in question, for one (1) molecule of maleic anhydride, there is/are X molecule(s) of styrene monomer(s) present during the grafting reaction.

The term “graft”, of maleic anhydride or styrene monomers, is understood to mean any sequence of maleic anhydride or styrene monomer grafted directly or indirectly onto the PLA chain. Thus, a graft may consist of an independent unit grafted onto said PLA chain, in which case said graft is counted as one maleic anhydride or styrene monomer unit. However, the term “graft” may also consist of a branch, grafted onto the PLA chain, said branch comprising one or more maleic anhydride and/or styrene monomer units, in which case the number of maleic anhydride units present on the branch in question must be counted as maleic anhydride “graft(s)” and the number of styrene monomer units present on the branch in question must be counted as styrene monomer “graft(s)”.

### MFI Test

The first test performed on the compositions is a measurement of the MFI (Melt Flow Index) at 190° C. (Celsius) under 2.16 kg (kilos), according to standard ISO 1133:

| | MFI measured |
|---|---|
| Composition No. 1 | 18 |
| Composition No. 2 | 13.3 |
| Composition No. 3 | 9.2 |
| Composition No. 4 | 5.8 |
| Composition No. 5 | 2 |
| Composition No. 6 | 1.4 |
| Extruded PLA 2003D | 3 |

### Coloring Test

The second test performed on the compositions is a measurement of the yellowness index according to standard ASTM E313-96:

| | Yellowness index |
|---|---|
| Test specimen No. 1 | 92 |
| Test specimen No. 2 | 65 |
| Test specimen No. 3 | 35 |
| Test specimen No. 4 | 20 |
| Test specimen No. 5 | 15 |
| Test specimen No. 6 | 12 |
| Extruded PLA 2003D | 10 |

### Thermal Stability Test

The third and last test performed on the compositions is a measurement of thermal stability at 180° C. under a stream of nitrogen (PHYSICA MCR301 rheometer, parallel planes 25 mm in diameter, 10 minutes at 1 rad·s⁻¹). This measurement of thermal stability is expressed in % variation of the viscosity at 180° C. and 1 rad·s⁻¹ as a function of time.

It will be noted that the tests on the composition according to the invention are performed with cografting of maleic anhydride and styrene monomers, but the applicant is able to generalize its results, possibly with slightly poorer or inferior advantages to those obtained with this particular cografting, in respect of all the unsaturated acid anhydrides and of the activating comonomers listed hereinabove.

1. A polymer composition, said polymer having a main chain consisting of a polylactic acid, the main chain comprising a plurality of unsaturated acid anhydride grafts, characterized in that said main chain also comprises activating comonomer grafts.

2. The composition as claimed in claim 1, characterized in that the unsaturated acid anhydride grafts consist of maleic anhydride.

3. The composition as claimed in claim 1 or 2, characterized in that the activating comonomer grafts consist of styrene monomers.

4. The composition as claimed in claim 3, characterized in that the styrene monomers consist of styrene.

5. The composition as claimed in any one of the preceding claims, characterized in that the amount of activating comonomers in the composition is between 0.011 and 2.1% by weight, such that in the composition said activating comonomers represent between 0.01 and 2 molar equivalents of the unsaturated acid anhydride.

6. The composition as claimed in claim 5, characterized in that the amount of activating comonomers in the composition is between 1.2 and 1.9% by weight, such that in the composition the activating comonomers represent between 1.1 and 1.8 molar equivalents of the unsaturated acid anhydride.

7. The composition as claimed in any one of the preceding claims, characterized in that it also comprises additives present at between 10 and 50 000 ppm and in that the additives comprise antioxidants, UV protection agents, processing aids, such as fatty amides, stearic acid and salts thereof, fluoropolymers, antifogging agents, antiblocking agents, such as silica or talc, antistatic agents, nucleating agents and colorants.

8. The composition as claimed in any one of the preceding claims, characterized in that the polymer also comprises at least one secondary chain consisting of a polylactic acid.

9. The composition as claimed in claim 8, characterized in that the secondary chain comprises at least one unsaturated acid anhydride graft, preferably maleic anhydride, and/or at least one activating comonomer graft, preferably styrene monomers and more preferably styrene.

10. A method of manufacture of the polymer composition as claimed in any one of the preceding claims, characterized in that it comprises a step of extrusion, via an extruder, of the polylactic acid (PLA) polymer, in the presence of radical generators, unsaturated acid anhydride, preferably maleic anhydride, and activating monomers, preferably styrene monomers and more preferably styrene; the temperature during this extrusion step being chosen so that the polylactic acid polymer is present in the molten state and that the radical generator entirely decomposes during said step.

11. The method as claimed in claim 10, characterized in that the polylactic acid (PLA) polymer, the radical generator, the unsaturated acid anhydride and the activating monomers are introduced into the extruder at the same time, either with all or some of these elements having been mixed beforehand to form a uniform mixture or with all or some of these elements being introduced simultaneously into the extruder.

12. The method as claimed in claim 10 or 11, characterized in that it comprises a final step of venting.

13. A multilayer structure, such as a film or a sheet, comprising at least three adjacent polymer layers, namely a central binder-forming layer having the primary role of ensuring bonding between the two peripheral layers, characterized in that the central layer comprises the composition as claimed in any one of claims 1 to 9.
